(19) United States
(12) Patent Application Publication
(10) Pub. No.: US 2011/0269625 A1
(43) Pub. Date: Nov. 3, 2011

(54) Synergistic insecticidal mixtures

(75) Inventors: Wolfram Andersch, Bergisch Gladbach (DE); Bernd Springer, Koln (DE); Heike Hungenberg, Langenfeld (DE)

(73) Assignee: Bayer CropScience AG, Monheim (DE)

(21) Appl. No.: 13/142,639

(22) PCT Filed: Dec. 16, 2009
(86) PCT No.: PCT/EP09/09008

§ 371 Date: Jun. 29, 2011

(30) Foreign Application Priority Data
Dec. 29, 2008 (EP) 081873032.7

(51) Int. Cl. A01N 53/06; A01P 7/04; A01P 3/00; A01P 5/00; A01P 1/00; A01C 1/06; A01P 7/02

(52) U.S. Cl. 504/100; 514/342; 514/357

(57) ABSTRACT

The present invention relates to mixtures of transfluthrin and thiacloprid or acetamiprid, and to those mixtures which comprise at least one further insecticidal and/or fungicidal component. The invention further relates to the use of these mixtures for control of animal pests, especially in seed treatment, and by means of granules in the soil.

The present invention relates to novel active ingredient combinations which comprise, as active ingredients, transfluthrin and thiacloprid, and possess very good insecticidal, acaricidal and nematicidal properties.

Transfluthrin of the formula (I)

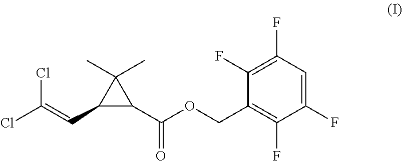

is known from EP 0 279 325.

It is already known that transfluthrin can be used for control of animal pests, especially of insects, arachnids or nematodes.

It is additionally known that thiacloprid of the formula (II)

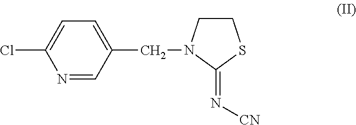

is suitable for control of animal pests, especially insects. Thiacloprid is known from EP 0 235 725.

It is also known that acetamiprid of the formula (III)

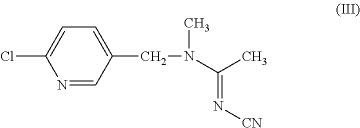

is suitable for control of animal pests, especially insects. Acetamiprid is known from WO 91/04965.

The efficacy of the individual compounds is good but, at low application rates or against individual pests, in some cases does not meet the high demands placed on insecticides, nematicides or acaricides.

It has now been found that mixtures comprising transfluthrin and at least thiacloprid or acetamiprid are synergistically active and are suitable for control of animal pests. Due to this synergism, it is possible to use much smaller amounts of active ingredient, which means that the effect of the mixture is greater than the effect of the individual components.

The ratio of the active ingredients used relative to one another, and the total amount of the mixture to be employed, depend on the type and the occurrence of the insects. The optimal ratios and total amounts used can be determined by test series in each application.

In a preferred embodiment of the invention, the weight ratio of transfluthrin to thiacloprid is between 1000:1 and 1:125, preferably between 125:1 and 1:50 and more preferably between 25:1 and 1:5.

In a further embodiment, the active ingredient combination of transfluthrin and thiacloprid or acetamiprid comprises at least one further component with an effect against insects, spider mites or nematodes.

In a further preferred embodiment, the active ingredient combination of transfluthrin or acetamiprid and thiacloprid comprises at least one further component with an effect against insects, spider mites or nematodes, which is selected from the following list:

(1) Acetylcholine esterase (AChE) inhibitors, for example
carbamates, for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC and xylylcarb; or organophosphates, for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-5-methyl, demeton-5-methylsulphone, dialifos, diazinon, dichlofenthion, dichlorvos/DDVP, dicrotophos, dimethoate, dimethylvinphos, dioxabenzofos, disulphoton, EPN, ethion, ethoprophos, etrimfos, famphur, fenamiphos, fenitrothion, fensulphothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulphotep, sulprofos, tebupirimfos, temephos, terbufos, tetrachlorvinphos, thiometon, triazophos, trichlorfon, vamidothion, and imicyafos.
(2) GABA-gated chloride channel antagonists, for example
organochlorines, for example camphechlor, chlordane, endosulfan, gamma-HCH, HCH, heptachlor, lindane and methoxychlor; or
fiproles (phenylpyrazoles), for example acetoprole, ethiprole, fipronil, pyrafluprole, pyriprole, vaniliprole.
(3) Sodium-channel modulators/voltage-dependent sodium channel blockers, for example
pyrethroids, for example acrinathrin, allethrin (d-cis-trans, d-trans), beta-cyfluthrin, bifenthrin, bioallethrin, bioallethrin-S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrin (pyrethrum), eflusilanat;
DDT; or methoxychlor.
(4) Nicotinergic acetylcholine receptor agonists/antagonists, for example
Chloronicotinyls, for example acetamiprid, clothianidin, dinotefuran, imidacloprid, imidaclothiz, nitenpyram, nithiazine, thiamethoxam, AKD-1022, nicotine, bensultap, cartap, thiosultap-sodium, and thiocylam.
(5) Allosteric acetylcholine receptor modulators (agonists), for example
spinosyns, for example spinosad and spinetoram.
(6) Chloride channel activators, for example
mectins/macrolides, for example abamectin, emamectin, emamectin benzoate, ivermectin, lepimectin, and milbemectin; or
juvenile hormone analogues, for example hydroprene, kinoprene, methoprene, epofenonane, triprene, fenoxycarb, pyriproxifen, and diofenolan.
(7) Active ingredients with unknown or nonspecific mechanisms of action, for example
fumigants, for example methyl bromide, chloropicrin and sulphuryl fluoride;
selective antifeedants, for example cryolite, pymetrozine, pyrifluquinazon and flonicamid; or
mite growth inhibitors, for example clofentezine, hexythiazox, etoxazole.
(8) Inhibitors of oxidative phosphorylation, ATP disruptors, for example
diafenthiuron;
organotin compounds, for example azocyclotin, cyhexatin and fenbutatin oxide; or propargite, tetradifon.
(9) Oxidative phosphorylation decouplers which interrupt the H-proton gradient, for example
chlorfenapyr, binapacyrl, dinobuton, dinocap and DNOC.
(10) Microbial disruptors of the insect gut membrane, for example Bacillus thuringiensis strains.
(11) Chitin biosynthesis inhibitors, for example benzoylureas, for example bistrifluoron, chlorfluazuron, diflubenzuron, fluazuron, flucycloxuron, flufenoxuron, hexaflumuron, lufenuron, novaluron, noviflumuron, penfluoron, teflubenzuron or triflumuron.

### (12) Buprofezin.

(13) Moulting disruptors, for example cyromazine.
(14) Ecdysone agonists/disruptors, for example
diacylhydrazines, for example chromafenozide, halofenozide, methoxyfenozide, tebufenozide, and fufenozide (JS118); or
azadirachtin.
(15) Octopaminergic agonists, for example amitraz;
(16) Site III electron transport inhibitors/site II electron transport inhibitors, for example
hydramethylnon; acequinocyl; fluacrypyrim; or cyflumetofen and cyenopyrafen.
(17) Electron transport inhibitors, for example
site I electron transport inhibitors from the group of the METI acaricides, for example fenazaquin, fenpyroximate, pyrimidifen, pyridaben, tebufenpyrad, tolfenpyrad, and rotenone; or
voltage-dependent sodium channel blockers, for example indoxacarb and metaflumizone.
(18) Fatty acid biosynthesis inhibitors, for example tetronic acid derivatives, for example spirodiclofen and spiromesifen; or
tetramic acid derivatives, for example spirotetramat.
(19) Neuronal inhibitors with unknown mechanism of action, for example bifenazate.
(20) Ryanodin receptor effectors, for example diamides, for example flubendiamide, (R)-, (S)-3-chloro-N¹-{2-methyl-4-[1,2,2,2-tetrafluoro-1-(trifluoromethyl)ethyl]phenyl}-N²-(1-methyl-2-methylsulphonylethyl)phthalamide, chlorantraniliprole (Rynaxypyr), or cyantraniliprole (Cyazypyr).
(21) Further active ingredients with unknown mechanism of action, for example amidoflumet, benclothiaz, benzoximate, bromopropylate, buprofezin, chinomethionat, chlordimeform, chlorobenzilate, clothiazoben, cycloprene, dicofol, dicyclanil, fenoxacrim, fentrifanil, flubenzimine, flufenerim, flutenzin, gossyplure, japonilure, metoxadiazone, petroleum, potassium oleate, pyridalyl, sulfluramid, tetrasul, triarathene, or verbutin; or the following known active compounds:
4-{[(6-bromopyrid-3-yl)methyl](2-fluoroethyl)amino}furan-2(5H)-one (known from WO 2007/115644), 4-{[(6-fluoropyrid-3-yl)methyl](2,2-difluoroethyl)amino}furan-2(5H)-one (known from WO 2007/115644), 4-{[(2-chloro-1,3-thiazol-5-yl)methyl] (2-fluoroethyl)amino}furan-2(5H)-one (known from WO 2007/115644), 4-{[(6-chloropyrid-3-yl)methyl](2-fluoroethyl)amino}furan-2(5H)-one (known from WO 2007/115644), 4-{[(6-chloropyrid-3-yl)methyl](2,2-difluoroethyl)amino}furan-2(5H)-one (known from WO 2007/115644), 4-{[(6-chloro-5-fluoropyrid-3-yl)methyl] (methyl)amino}furan-2(5H)-one (known from WO 2007/115643), 4-{[(5,6-dichloropyrid-3-yl)methyl](2-fluoroethyl)amino}furan-2(5H)-one (known from WO 2007/115646), 4-{[(6-chloro-5-fluoropyrid-3-yl)methyl](cyclopropyl)amino}furan-2(5H)-one (known from WO 2007/115643), 4-{[(6-chloropyrid-3-yl)methyl](cyclopropyl)amino}furan-2(5H)-one (known from EP-A-0 539 588), 4-{[(6-chloropyrid-3-yl)methyl](methyl)amino}furan-2(5H)-one (known from EP-A-0 539 588), [(6-chloropyridin-3-yl)methyl](methyl)oxido-λ⁴-sulphanylidenecyanamide (known from WO 2007/149134), [1-(6-chloropyridin-3-yl)ethyl](methyl)oxido-λ⁴-sulphanylidenecyanamide (known from WO 2007/149134) and its diastereomers (A) and (B)

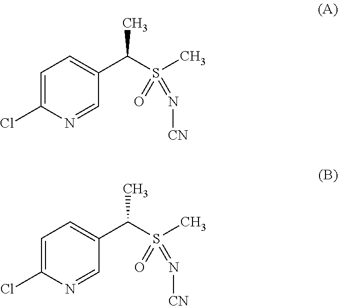

(likewise known from WO 2007/149134), [(6-trifluoromethylpyridin-3-yl)methyl](methyl)oxido-λ⁴-sulphanylidenecyanamide (known from WO 2007/095229), or [1-(6-trifluoromethylpyridin-3-yl)ethyl](methyl)oxido-λ⁴-sulphanylidenecyanamide (known from WO 2007/149134) and its diastereomers (C) and (D), namely sulfoxaflor

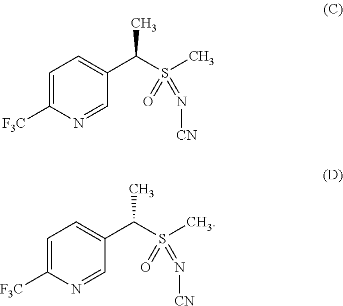

(likewise known from WO 2007/149134).

In a further embodiment, the active ingredient combination of transfluthrin and thiacloprid or acetamiprid comprises at least one further antimicrobially or fungicidally active component.

In a further preferred embodiment, the active ingredient combination of transfluthrin and thiacloprid comprises at least one further antimicrobially or fungicidally active component, which is selected from the following list:

(1) Nucleic acid synthesis inhibitors, for example benalaxyl, benalaxyl-M, bupirimate, clozylacon, dimethirimol, ethirimol, furalaxyl, hymexazol, metalaxyl, metalaxyl-M, ofurace, oxadixyl and oxolinic acid.
(2) Mitosis and cell division inhibitors, for example benomyl, carbendazim, chlorfenazole, diethofencarb, ethaboxam, fuberidazole, pencycuron, thiabendazole, thiophanate, thiophanate-methyl and zoxamide.
(3) Respiration inhibitors (respiratory chain inhibitors), for example diflumetorim as an inhibitor on complex I of the respiratory chain; bixafen, boscalid, carboxin, fenfuram, flutolanil, fluopyram, furametpyr, furmecyclox, isopyrazam (9R component), isopyrazam (9S component), mepronil, oxycarboxin, penthiopyrad, thifluzamid as inhibitors on complex II of the respiratory chain; amisulbrom, azoxystrobin, cyazofamid, dimoxystrobin, enestroburin, famoxadon, fenamidon, fluoxastrobin, kresoxim-methyl, metominostrobin, orysastrobin, picoxystrobin, pyraclostrobin, pyribencarb, trifloxystrobin as inhibitors on complex III of the respiratory chain.
(4) Decouplers, for example binapacryl, dinocap, fluazinam and meptyldinocap.
(5) ATP production inhibitors, for example fentin acetate, fentin chloride, fentin hydroxide and silthiofam.
(6) Amino acid and protein biosynthesis inhibitors, for example andoprim, blasticidin-S, cyprodinil, kasugamycin, kasugamycin hydrochloride hydrate, mepanipyrim and pyrimethanil.
(7) Signal transduction inhibitors, for example fenpiclonil, fludioxonil and quinoxyfen.
(8) Lipid and membrane synthesis inhibitors, for example biphenyl, chlozolinate, edifenphos, etridiazole, iodocarb, iprobenfos, iprodione, isoprothiolane, procymidone, propamocarb, propamocarb hydrochloride, pyrazophos, tolclofos-methyl and vinclozolin.
(9) Ergosterol biosynthesis inhibitors, for example aldimorph, azaconazole, bitertanol, bromuconazole, cyproconazole, diclobutrazole, difenoconazole, diniconazole, diniconazole-M, dodemorph, dodemorph acetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulphate, imibenconazole, ipconazole, metconazole, myclobutanil, naftifine, nuarimol, oxpoconazole, paclobutrazol, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, viniconazole and voriconazole.
(10) Cell wall synthesis inhibitors, for example benthiavalicarb, dimethomorph, flumorph, iprovalicarb, mandipropamid, polyoxins, polyoxorim, prothiocarb, validamycin A and valiphenal.
(11) Melanin biosynthesis inhibitors, for example carpropamid, diclocymet, fenoxanil, phthalide, pyroquilon and tricyclazole.
(12) Resistance inductors, for example acibenzolar-S-methyl, probenazole and tiadinil.
(13) Compounds with multi-site activity, for example Bordeaux mixture, captafol, captan, chlorothalonil, copper naphthenate, copper oxide, copper oxychloride, copper preparations, for example copper hydroxide, copper sulphate, dichlofluanid, dithianon, dodine and the free base thereof, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulphur and sulphur preparations, for example calcium polysulphide, thiram, tolylfluanid, zineb and ziram.
(14) Further compounds, for example 2,3-dibutyl-6-chlorothieno[2,3-d]pyrimidin-4(3H)-one, ethyl (2Z)-3-amino-2-cyano-3-phenylprop-2-enoate, N-[2-(1,3-dimethylbutyl)phenyl]-5-fluoro-1,3-dimethyl-1H-pyrazole-4-carboxamide, N-{2-[1,1′-bi(cyclopropyl)-2-yl]phenyl}-3-(difluoromethyl)-1-methyl-1H-pyrazole-4-carboxamide, 3-(difluoromethyl)-1-methyl-N-(3′,4′,5′-trifluorobiphenyl-2-yl)-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, (2E)-2-(2-{[6-(3-chloro-2-methylphenoxy)-5-fluoropyrimidin-4-yl]oxy}phenyl)-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, N-(3-ethyl-3,5,5-trimethylcyclohexyl)-3-(formylamino)-2-hydroxybenzamide, 5-methoxy-2-methyl-4-(2-{[({(1E)-1-[3-(trifluoromethyl)phenyl]ethylidene}amino) oxy]methyl}phenyl)-2,4-dihydro-3H-1,2,4-triazol-3-one, (2E)-2-(methoxyimino)-N-methyl-2-(2-{[({(1E)-1-[3-(trifluoromethyl)phenyl]ethylidene}amino)oxy]methyl}phenyl)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N-ethyl-N-methyl-N′-{2-methyl-5-(trifluoromethyl)-4-[3-(trimethyl-silyl)propoxy]phenyl}imidoformamide, N′-{5-(difluoromethyl)-2-methyl-4-[3-(trimethylsilyl)propoxy]phenyl}-N-ethyl-N-methylimidoformamide, 0-{1-[(4-methoxy-phenoxy)methyl]-2,2-dimethylpropyl}1H-imidazole-1-carbothioate, N-[2-(4-{[3-(4-chlorophenyl)prop-2-yn-1-yl]oxy}-3-methoxyphenyl)ethyl]-N²-(methylsulphonyl)valinamide, 5-chloro-7-(4-methylpiperidin-1-yl)-6-(2,4,6-trifluorophenyl) [1,2,4]triazolo[1,5-a]pyrimidine, 5-amino-1,3,4-thiadiazole-2-thiole, propamocarb-fosetyl, 1-[(4-methoxyphenoxy)methyl]-2,2-dimethylpropyl 1H-imidazole-1-carboxylate, 1-methyl-N-[2-(1,1,2,2-tetrafluoroethoxy)phenyl]-3-(trifluoromethyl)-1H-pyrazole-4-carboxamide, 2,3,5,6-tetrachloro-4-(methylsulphonyl)pyridine, 2-butoxy-6-iodo-3-propyl-4H-chromen-4-one, 2-phenylphenol and its salts, 3-(difluoromethyl)-1-methyl-N-[2-(1,1,2,2-tetrafluoroethoxy)phenyl]-1H-pyrazole-4-carboxamide, 3,4,5-trichloropyridine-2,6-dicarbonitrile, 3-[5-(4-chlorophenyl)-2,3-dimethylisoxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 8-hydroxyquinoline, 8-hydroxyquinoline sulphate, 5-methyl-6-octyl-3,7-dihydro[1,2,4]triazolo[1,5-a]pyrimidine-7-amine, 5-ethyl-6-octyl-3,7-dihydro[1,2,4]triazolo[1,5-a]pyrimidine-7-amine, benthiazole, bethoxazin, capsimycin, carvone, chinomethionat, chloroneb, cufraneb, cyflufenamide, cymoxanil, cyprosulfamide, dazomet, debacarb, dichlorophen, diclomezine, dicloran, difenzoquat, difenzoquat methylsulphate, diphenylamine, ecomat, ferimzone, flumetover, fluopicolide, fluoromide, flusulfamide, flutianil, fosetyl-aluminium, fosetyl-calcium, fosetyl-sodium, hexachlorobenzene, irumamycin, isotianil, methasulfocarb, methyl (2E)-2-{2-[({cyclopropyl[(4-methoxyphenyl)imino]methyl}thio)methyl]phenyl}-3-methoxyacrylate, methyl isothiocyanate, metrafenone, (5-bromo-2-methoxy-4-methylpyridin-3-yl)(2,3,4-trimethoxy-6-methylphenyl)methanone, mildiomycin, tolnifanide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(Z)-[(cyclopropylmethoxy)imino][6-(difluoromethoxy)-2,3-difluorophenyl]methyl}-2-phenylacetamide, N-{(E)-[(cyclopropylmethoxy)imino][6-(difluoromethoxy)-2,3-difluorophenyl]methyl}-2-phenylacetamide, natamycin, nickel dimethyldithiocarbamate, nitrothal-isopropyl, octhilinone, oxamocarb, oxyfenthiin, pentachlorophenol and salts thereof, phenazine-1-carboxylic acid, phenothrin, phosphoric acid and salts thereof, propamocarb fosetylate, propanosine-sodium, proquinazid, pyrrolnitrin, quintozene, S-prop-2-en-1-yl 5-amino-2-(1-methylethyl)-4-(2-methylphenyl)-3-oxo-2,3-dihydro-1H-pyrazole-1-carbothioate, tecloftalam, tecnazene, triazoxide, trichlamide, 5-chloro-N′-phenyl-N′-prop-2-yn-1-ylthiophene-2-sulphonohydrazide and azarilamide.
The inventive active ingredient combinations preferably further comprise a biologically active component. A biologically active component in the context of this invention is especially, but not exclusively, a spore-forming bacterium with a documented agricultural benefit. More particularly, this is a bacterium which colonizes roots, for example rhizobacterium. Agricultural benefit relates, inter alia, to the ability of the bacterium to protect a plant from some or all adverse influences, phytopathogenic fungi and/or soil-dwelling animals, for example nematodes or Aschelminthes. The protection of the plant from the plant-parasitic nematodes and fungi can be caused, for example, by chitinolytic, proteolytic or collagenolytic activities of bacteria. In addition, the effect of protection of the plant can occur through the synthesis of chemically acutely toxic compounds by the bacteria. In addition, in the context of the invention, a proven agricultural benefit for the crop plants means one of the following effects: improved germination of the seed of the plant, increased growth of the plant, strengthening of the plant and of the growing plant, and of the resistance of the plant to harmful organisms, and an increased yield.

The bacteria in the context of this invention which have a proven benefit for the plant may be, for example: Bacillus agri, Bacillus aizawai, Bacillus albolactis, Bacillus amyloliquefaciens, Bacillus cereus, Bacillus coagulans, Bacillus endoparasiticus, Bacillus endorhythmos, Bacillus firmus, Bacillus kurstaki, Bacillus lacticola, Bacillus lactimorbus, Bacillus lactis, Bacillus laterosporus, Bacillus lentimorbus, Bacillus licheniformis, Bacillus megaterium, Bacillus medusa, Bacillus metiens, Bacillus natto, Bacillus nigrificans, Bacillus popillae, Bacillus pumilus, Bacillus siamensis, Bacillus sphaericus, Bacillus spp., Bacillus subtilis, Bacillus thuringiensis, Bacillus uniflagellatu, and those bacteria from the Bacillus genus category from “Bergey's Manual of Systematic Bacteriology, 1st Edition (1986)”, either alone or in combination.

A particularly preferred embodiment comprises the inventive active ingredient combinations with a biologically active component selected from the following list: Bacillus firmus ENCM I-1582 spores and/or Bacillus cereus strain CNCM I-1562 spores, which are known from U.S. Pat. No. 6,406,690, the disclosure of which forms an integral part of this application.

In a further particularly preferred embodiment, the active ingredient combinations comprise, as a biologically active component, Bacillus amyloliquefaciens IN937a, Bacillus subtillis strain GB03 or Bacillus pumulis strain GB34. Combinations of these five bacteria species and of further spore-forming root-colonizing bacteria which have the above-described beneficial properties for the plants are also part of this invention.

The amounts of the biologically active components as part of the inventive active ingredient combinations vary according to the formulation selected or plant or plant propagation material to be used. In a preferred embodiment, the inventive compositions comprising the inventive active ingredient combinations comprise the biologically active components within a range of 2-80 percent by weight, based on the overall formulation. More preferably, this range is between 5-65 percent by weight and most preferably within a range of 10-60 percent by weight, the weight being that of the entire formulation of the composition.

The inventive treatment of the plants and plant parts with the active ingredient combinations is effected directly or by allowing them to act on their surroundings, habitat or storage space by the customary treatment methods, for example by dipping, spraying, evaporating, fogging, scattering, painting on, injecting, and, in the case of propagation material, especially in the case of seeds, also by applying one or more coats.

The inventive active ingredient combinations are especially suitable for treatment of seed. Preference is given to the inventive combinations mentioned above as preferred or particularly preferred. This is because a large part of the damage to crop plants caused by pests occurs at an early stage, as a result of infestation of the seed during storage and after the introduction of the seed into the soil, and during and immediately after germination of the plants. This phase is particularly critical since the roots and shoots of the growing plant are particularly sensitive and even minor damage can lead to the death of the whole plant. There is therefore especially great interest in protecting the seed and the germinating plant by the use of suitable compositions.

The control of pests by the treatment of the seed of plants has long been known and is the subject of continuous improvements. Nevertheless, the treatment of seed gives rise to a series of problems which cannot always be solved in a satisfactory manner. For instance, it is desirable to develop methods for protecting the seed and the germinating plant, which obviate the need for additional application of crop protection products after sowing or after emergence of the plants. It is also desirable to optimize the amount of the active ingredient used so as to provide the best possible protection for the seed and the germinating plant from infestation by pests, but without damage to the plant itself by the active ingredient used. More particularly, methods for treatment of seed should also involve the intrinsic insecticidal properties of transgenic plants in order to achieve optimal protection of the seed and of the germinating plant with minimal expenditure of crop protection products.

The present invention therefore especially also relates to a method for protection of seed and germinating plants from attack by pests, by treating the seed with an inventive active ingredient combination. The inventive method for protecting seed and germinating plants from attack by pests comprises a method wherein the seed is treated simultaneously with an active ingredient of the formula I and mixing partner. It also comprises a method wherein the seed is treated at different times with an active ingredient of the formula I and mixing partner. The invention likewise relates to the use of the inventive active ingredient combinations for treatment of seed to protect the seed and the resulting plant from pests. The invention further relates to seed which has been treated with an inventive active ingredient combination for protection from pests. The invention also relates to seed which has been treated simultaneously with an active ingredient of the formula I and mixing partner. The invention further relates to seed which has been treated at different times with an active ingredient of the formula I and mixing partner. In the case of seed which has been treated at different times with an active ingredient of the formula I and mixing partner, the individual active ingredients of the inventive composition may be present on the seed in different layers. In this case, the layers comprising an active ingredient of the formula I and mixing partner may optionally be separated by an intermediate layer. The invention also relates to seed wherein an active ingredient of the formula I and mixing partner have been applied as part of a coating or as a further layer or further layers in addition to a coating.

One of the advantages of the present invention is that the particular systemic properties of the inventive active ingredient combinations mean that the treatment of the seed with these active ingredient combinations not only protects the seed itself but also the resulting plants after emergence from pests. In this way, the immediate treatment of the crop at the time of sowing or shortly thereafter can be dispensed with.

A further advantage is the synergistic increase in insecticidal efficacy of the inventive active ingredient combinations compared to the single insecticidally active ingredient, said efficacy exceeding the expected efficacy of the two active ingredients applied individually.

It is likewise considered to be advantageous that the inventive active ingredient combinations can also be used especially in transgenic seed, the plants resulting from this seed being capable of expressing a protein directed against pests. By virtue of the treatment of such seed with the inventive active ingredient combinations, particular pests can already be controlled by the expression of the protein, for example the insecticidal protein, and the inventive active ingredient combinations can additionally protect the seed from damage.

The inventive active ingredient combinations are suitable for protection of seed of any plant variety as already mentioned above, which is used in agriculture, in the greenhouse, in forests or in horticulture. More particularly, this is the seed of maize, peanut, canola, oilseed rape, poppy, soya beans, cotton, beet (for example sugar beet and fodder beet), rice, millet, wheat, barley, oats, rye, sunflower, tobacco, potatoes or vegetables (for example tomatoes, cabbage species). The inventive active ingredient combinations are likewise suitable for treatment of the seed of fruit plants and vegetables as already mentioned above. Of particular significance is the treatment of the seed of maize, soya beans, cotton, wheat and canola or oilseed rape.

As already mentioned above, the treatment of transgenic seed with an inventive active ingredient combination is also of particular significance. This is the seed of plants which generally comprise at least one heterologous gene which governs the expression of a polypeptide with insecticidal properties in particular. In this context, the heterologous genes in transgenic seed may originate from microorganisms such as Bacillus, Rhizobium, Pseudomonas, Serratia, Trichoderma, Clavibacter, Glomus or Gliocladium. The present invention is particularly suitable for the treatment of transgenic seed which comprises at least one heterologous gene which originates from Bacillus sp. and whose gene product shows efficacy against the European Corn Borer and/or the Corn Rootworm. The gene is more preferably a heterologous gene which originates from Bacillus thuringiensis.

In the context of the present invention, the inventive active ingredient combination is applied to the seed alone or in a suitable formulation. Preferably, the seed is treated in a state in which it is sufficiently stable for no damage to occur in the course of treatment. In general, the seed can be treated at any time between harvest and sowing. It is customary to use seed which has been separated from the plant and freed from cobs, shells, stalks, coats, hairs or the flesh of the fruits.

When treating the seed, care must generally be taken that the amount of the inventive active ingredient combination applied to the seed and/or of further additives is selected such that the germination of the seed is not impaired, or that the resulting plant is not damaged. This has to be borne in mind particularly in the case of active ingredients which can have phytotoxic effects at certain application rates.

The mixtures specified above as preferred preferably do not comprise any further insecticidally active constituent.

Given good plant compatibility and favourable homeotherm toxicity, the active ingredient combinations are suitable for controlling animal pests, especially insects, arachnids and nematodes, which are encountered in agriculture, in forestry, in the protection of stored products and of materials, and in the hygiene sector. They can preferably be used as crop protection compositions in leaf and soil treatment.

They are active against normally sensitive and resistant species, and against all or some stages of development. The abovementioned pests include:

From the order of the Anoplura (Phthiraptera), for example, Damalinia spp., Haematopinus spp., Linognathus spp., Pediculus spp., Trichodectes spp.

From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vacates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.

From the order of the Collembola, for example, Onychiurus armatus.

From the order of the Dermaptera, for example, Forficula auricularia.

From the order of the Diplopoda, for example, Blaniulus guttulatus.

From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp. Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Anion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is also possible to control protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis, Vespa spp.

From the order of the Isopoda, for example, Armadillidium vulgare, Oniscus asellus, Porcellio scaber.

From the order of the Isoptera, for example, Reticulitermes spp., Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Chematobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp., Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.

From the order of the Thysanura, for example, Lepisma saccharina.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Xiphinema spp.

The active ingredient combinations are especially suitable for controlling nematodes and insects.

All plants and plant parts can be treated in accordance with the invention. Plants are understood here to mean all plants and plant populations, such as desired and undesired wild plants or crop plants (including naturally occurring crop plants). Crop plants may be plants which can be obtained by conventional breeding and optimization methods or by biotechnological and genetic engineering methods or combinations of these methods, including the transgenic plants and including the plant varieties which are protectable and non-protectable by plant breeders' rights. Plant parts are understood to mean all parts and organs of plants above and below the ground, such as shoot, leaf, flower and root, examples of which include leaves, needles, stalks, stems, flowers, fruit bodies, fruits, seeds, roots, tubers and rhizomes. Parts of plants also include harvested plants and vegetative and generative propagation material, for example seedlings, tubers, rhizomes, cuttings and seeds.

Emphasis should be given here to the particularly advantageous effect of the inventive active ingredient combinations with regard to use in cereal plants, for example wheat, oats, barley, spelt, triticale and rye, but also in maize, millet/sorghum, rice, sugarcane, soya, sunflowers, potatoes, cotton, oilseed rape, canola, tobacco, sugar beet, fodder beet, asparagus, hops, and also fruit plants (including pome fruit, for example apples and pears, stone fruit, for example peaches, nectarines, cherries, plums and apricots, citrus fruits, for example oranges, grapefruits, limes, lemons, kumquats, mandarins and satsumas, nuts, for example pistachios, almonds, walnuts and pecans, tropical fruits, for example mangoes, papayas, pineapples, dates and bananas, and grapes) and vegetables (including leaf vegetables, for example endives, lamb's lettuce, Florence fennel, head and picking lettuce, chard, spinach and chicory, Brassica, for example cauliflower, broccoli, Chinese cabbage, kale (winter kale or curly kale), kohlrabi, Brussels sprouts, red cabbage, white cabbage and Savoy cabbage, fruit vegetables, for example aubergines, cucumbers, bell peppers, table pumpkins, tomatoes, courgettes and sweetcorn, root vegetables, for example celeriac, spring turnips, carrots including yellow varieties, radishes, horseradish, beetroot, salsify and celery, legumes, for example peas and beans, allium vegetables, for example leeks and onions). The inventive active ingredient combinations are especially suitable for treatment of the seed of maize and sunflowers.

The inventive treatment of the plants and plant parts with the active ingredient combinations is effected directly or by allowing them to act on the surroundings, habitat or storage space by the customary treatment methods, for example by dipping, spraying, evaporating, fogging, scattering, painting on, and, in the case of propagation material, especially in the case of seeds, also by applying one or more coats.

The active ingredient combinations can be converted to the customary formulations, such as solutions, emulsions, wettable powders, suspensions, powders, dusts, pastes, soluble powders, granules, suspoemulsion concentrates, natural and synthetic substances impregnated with active ingredient, and also microencapsulations in polymeric substances.

These formulations are produced in a known manner, for example by mixing the active ingredients with extenders, i.e. liquid solvents, and/or solid carriers, optionally with the use of surfactants, i.e. emulsifiers and/or dispersants, and/or foam formers.

If the extender used is water, it is also possible to use, for example, organic solvents as auxiliary solvents. Useful liquid solvents are essentially: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Useful solid carriers include:

for example ammonium salts and natural rock flours, such as kaolins, aluminas, talc, chalk, quartz, attapulgite, montmorillonite or diatomaceous earth, and synthetic rock flours, such as finely divided silica, alumina and silicates; useful solid carriers for granules include: for example crushed and fractionated natural rocks such as calcite, marble, pumice, sepiolite and dolomite, and also synthetic granules of inorganic and organic flours, and granules of organic material such as paper, sawdust, coconut shells, maize cobs and tobacco stalks; useful emulsifiers and/or foam formers include: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; useful dispersants are nonionic and/or ionic substances, for example from the classes of the alcohol-POE and/or -POP ethers, acid and/or POP POE esters, alkylaryl and/or POP POE ethers, fat and/or POP POE adducts, POE- and/or POP-polyol derivatives, POE- and/or POP-sorbitan or -sugar adducts, alkyl or aryl sulphates, alkyl- or arylsulphonates and alkyl or aryl phosphates or the corresponding PO-ether adducts. Further suitable oligomers or polymers are, for example, those derived from vinylic monomers, from acrylic acid, from EO and/or PO alone or in combination with, for example, (poly)alcohols or (poly)amines. It is also possible to use lignin and its sulphonic acid derivatives, unmodified and modified celluloses, aromatic and/or aliphatic sulphonic acids, and also adducts thereof with formaldehyde.

In the formulations it is possible to use tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids.

It is possible to use dyes such as inorganic pigments, for example iron oxide, titanium oxide and Prussian Blue, and organic dyes such as alizarin dyes, azo dyes and metal phthalocyanine dyes, and trace nutrients such as salts of iron, manganese, boron, copper, cobalt, molybdenum and zinc.

Further additives may be perfumes, mineral or vegetable, optionally modified oils, waxes and nutrients (including trace nutrients), such as salts of iron, manganese, boron, copper, cobalt, molybdenum and zinc.

Additional components may be stabilizers, such as cold stabilizers, preservatives, antioxidants, light stabilizers or other agents which improve chemical and/or physical stability.

The formulations contain generally between 0.01 and 98% by weight of active ingredient, preferably between 0.5 and 90%.

The inventive active ingredient combinations may be present in their commercially available formulations and in the use forms, prepared from these formulations, as a mixture with other active ingredients, such as insecticides, attractants, steriliants, bactericides, acaricides, nematicides, fungicides, growth regulators, herbicides, safeners, fertilizers or semiochemicals.

When used as insecticides, the inventive active ingredient combinations may also be present in their commercial formulations and in the use forms, prepared from these formulations, in a mixture with synergists. Synergists are compounds which enhance the action of the active ingredients, though the synergist added need not itself be active.

The active ingredient content of the use forms prepared from the commercially available formulations may vary within wide limits. The active ingredient concentration of the use forms may be from 0.0000001 to 95% by weight of active ingredient, preferably between 0.0001 and 1% by weight.

Application is effected in a customary manner appropriate for the use forms.

When used against hygiene pests and stored product pests, the active ingredient combinations feature an excellent residual action on wood and clay, and also good stability to alkali on limed substrates.

The inventive active ingredient combinations act not only against plant, hygiene and stored product pests, but also in the veterinary medicine sector against animal parasites (ectoparasites), such as hard ticks, soft ticks, mange mites, leaf mites, flies (biting and licking), parasitic fly larvae, lice, hair lice, feather lice and fleas.

The inventive active ingredient combinations are also suitable for controlling arthropods which attack agricultural livestock, for example cattle, sheep, goats, horses, pigs, donkeys, camels, buffalo, rabbits, chickens, turkeys, ducks, geese, honey-bees, other domestic animals, for example dogs, cats, caged birds, aquarium fish, and experimental animals, for example hamsters, guinea pigs, rats and mice. The control of these arthropods should reduce cases of death and reduced productivity (of meat, milk, wool, hides, eggs, honey etc.), such that more economic and easier animal husbandry is possible by use of the inventive active ingredient compositions.

The inventive active ingredient combinations are used in the veterinary sector in a known manner by enteral administration in the form of, for example, tablets, capsules, potions, drenches, granules, pastes, boluses, the feed-through process and suppositories, by parenteral administration, such as, for example, by injections (intramuscular, subcutaneous, intravenous, intraperitoneal and the like), implants, by nasal administration, by dermal use in the form, for example, of dipping or bathing, spraying, pouring on and spotting on, washing and powdering, and also with the aid of moulded articles containing the active ingredient, such as collars, ear marks, tail marks, limb bands, halters, marking devices and the like.

When used for cattle, poultry, domestic animals and the like, the active ingredients can be applied as formulations (for example powders, emulsions, flowables) comprising the active ingredients in an amount of 1 to 80% by weight, either directly or after 100- to 10 000-fold dilution, or they can be used as a chemical dip.

It has also been found that the inventive active ingredient combinations have a strong insecticidal action against insects which destroy industrial materials.

Industrial materials in the present context are understood to mean inanimate materials such as, preferably, plastics, adhesives, sizes, paper and card, leather, wood, timber products and coating compositions.

The materials to be protected from insect infestation are most preferably wood and timber products.

Wood and timber products which can be protected by the inventive composition or mixtures comprising the latter are understood to mean, for example:

construction timber, wooden beams, railway sleepers, bridge components, boat jetties, wooden vehicles, boxes, pallets, containers, telegraph poles, wood panelling, wooden windows and doors, plywood, chipboard, joinery, or wood products which are used quite generally in house building or in building joinery.

The active ingredient combinations can be employed as such, in the form of concentrates or generally customary formulations such as powders, granules, solutions, suspensions, emulsions or pastes.

The formulations mentioned can be produced in a manner known per se, for example by mixing the active ingredients with at least one solvent or diluent, emulsifier, dispersant and/or binder or fixing agent, water repellent, optionally siccatives and UV stabilizers, and optionally dyes and pigments, and also further processing auxiliaries.

The insecticidal compositions or concentrates used for preservation of wood and woodbase materials comprise the inventive active ingredient in a concentration of 0.0001 to 95% by weight, especially 0.001 to 60% by weight.

The amount of the compositions or concentrates used depends on the nature and occurrence of the insects and on the medium. The optimal amount used can be determined for each application by series of tests. In general, however, it is sufficient to use 0.0001 to 20% by weight, preferably 0.001 to 10% by weight, of the active ingredient, based on the material to be preserved.

The solvent and/or diluent used is an organic chemical solvent or solvent mixture and/or an oily or oil-like low-volatility organic chemical solvent or solvent mixture and/or a polar organic chemical solvent or solvent mixture and/or water, and optionally an emulsifier and/or wetting agent.

The organic chemical solvents used are preferably oily or oil-like solvents with an evaporation rate greater than 35 and a flashpoint above 30° C., preferably above 45° C. The low-volatility, water-insoluble, oily and oil-like solvents of this type which are used are corresponding mineral oils or aromatics fractions thereof or mineral oil-containing solvent mixtures, preferably white spirit, petroleum and/or alkylbenzene.

It is advantageous to use mineral oils having a boiling range from 170 to 220° C., white spirit having a boiling range from 170 to 220° C., spindle oil having a boiling range from 250 to 350° C., petroleum and aromatics having a boiling range from 160 to 280° C., terpentine oil and the like.

In a preferred embodiment, liquid aliphatic hydrocarbons having a boiling range from 180 to 210° C. or high-boiling mixtures of aromatic and aliphatic hydrocarbons having a boiling range from 180 to 220° C. and/or spindle oil and/or monochloronaphthalene, preferably α-monochloronaphthalene, are used.

The organic low-volatility oily or oil-like solvents with an evaporation rate greater than 35 and a flashpoint above 30° C., preferably above 45° C., can be replaced in part by volatile or medium-volatility organic chemical solvents, provided that the solvent mixture likewise has an evaporation rate greater than 35 and a flashpoint above 30° C., preferably above 45° C., and that the insecticide/fungicide mixture is soluble or emulsifiable in this solvent mixture.

In a preferred embodiment, some of the organic chemical solvent or solvent mixture is replaced by an aliphatic polar organic chemical solvent or solvent mixture. Preference is given to using organic chemical solvents containing hydroxyl and/or ester and/or ether groups, for example glycol ethers, esters or the like.

The organic chemical binders used in the context of the present invention are the synthetic resins and/or binding drying oils which are known per se, are water-dilutable and/or are soluble or dispersible or emulsifiable in the organic chemical solvents employed, especially binders consisting of or comprising an acrylate resin, a vinyl resin, for example polyvinyl acetate, polyester resin, polycondensation or polyaddition resin, polyurethane resin, alkyd resin or modified alkyd resin, phenolic resin, hydrocarbon resin, such as indene-coumarone resin, silicone resin, drying vegetable oils and/or drying oils and/or physically drying binders based on a natural and/or synthetic resin.

The synthetic resin used as the binder can be used in the form of an emulsion, dispersion or solution. The binders used may also be bitumen or bituminous substances at up to 10% by weight. In addition, it is possible to use dyes, pigments, water repellents, odour correctants and inhibitors or anticorrosives and the like, which are known per se.

According to the invention, the organic chemical binder present in the composition or concentrate is preferably at least one alkyd resin or modified alkyd resin and/or one drying vegetable oil. According to the invention, preference is given to using alkyd resins having an oil content of more than 45% by weight, preferably 50 to 68% by weight.

All or some of the binder mentioned may be replaced by a fixing agent (mixture) or a plasticizer (mixture). These additives are intended to prevent evaporation of the active ingredients and crystallization or precipitation. They preferably replace 0.01 to 30% of the binder (based on 100% of the binder used).

The plasticizers are from the chemical classes of phthalic esters such as dibutyl phthalate, dioctyl phthalate or benzyl butyl phthalate, phosphoric esters such as tributyl phosphate, adipic esters such as di(2-ethylhexyl)adipate, stearates such as butyl stearate or amyl stearate, oleates such as butyl oleate, glyceryl ethers or relatively high molecular weight glycol ethers, glyceryl esters and p-toluenesulphonic esters.

Fixing agents are based chemically on polyvinyl alkyl ethers, for example polyvinyl methyl ether, or ketones such as benzophenone or ethylenebenzophenone.

Useful solvents or diluents are especially also water, optionally in a mixture with one or more of the abovementioned organic chemical solvents or diluents, emulsifiers and dispersants.

Particularly effective preservation of wood is achieved by impregnation processes on a large industrial scale, for example vacuum, double vacuum or pressure processes.

The ready-to-use compositions can optionally also comprise other insecticides, and optionally one or more fungicides.

The inventive active ingredient combinations can likewise be used for protection of objects which come into contact with saltwater or brackish water, especially hulls, screens, nets, buildings, moorings and signaling systems, against fouling.

Fouling by sessile Oligochaeta, such as Serpulidae, and by mussels and species from the Ledamorpha group (goose barnacles), such as various Lepas and Scalpellum species, or by species from the Balanomorpha group (acorn barnacles), such as Balanus or Pollicipes species, increases the frictional drag of ships and, as a result, leads to a marked increase in operating costs owing to higher energy consumption and additionally frequent periods in the dry dock.

In addition to fouling by algae, for example Ectocarpus sp. and Ceramium sp., fouling by sessile Entomostraka groups, which come under the generic term Cirripedia (cirriped crustaceans), is of particular significance.

The inventive active ingredient combinations are also suitable for controlling animal pests, especially insects, arachnids and mites, which are found in enclosed spaces, for example dwellings, factory halls, offices, vehicle cabins and the like. They can be used for control of these pests in domestic insecticide products alone or in combination with other active ingredients and auxiliaries. They are active against sensitive and resistant species and against all developmental stages.

In the domestic insecticides sector, they can also be employed in combination with other suitable active ingredients, such as phosphoric esters, carbamates, pyrethroids, growth regulators or active ingredients from other known insecticide classes.

They are applied in aerosols, unpressurized spray products, for example pump and atomizer sprays, automatic fogging systems, foggers, foams, gels, evaporator products with evaporator tablets made of cellulose or plastic, liquid evaporators, gel and membrane evaporators, propeller-driven evaporators, energy-free or passive evaporation systems, moth papers, moth bags and moth gels, as granules or dusts, in baits for spreading or in bait stations.

When using the inventive active ingredient combinations, the application rates can be varied within a relatively wide range, depending on the kind of application. For the treatment of parts of plants, the application rates of active ingredient combination are generally between 0.1 and 10 000 g/ha, preferably between 10 and 1000 g/ha.

The expected action for a given combination of two active ingredients can be calculated according to S. R. Colby, Weeds 15 (1967), 20-22) as follows:

### If

X is the kill rate, expressed in % of the untreated control, using the active ingredient A at an application rate of m g/ha or in a concentration of m ppm,
Y is the kill rate, expressed in % of the untreated control, using the active ingredient B at an application rate of n g/ha or in a concentration of n ppm,
E is the kill rate, expressed in % of the untreated control, using the active ingredients A and B at application rates of m and n g/ha or in a concentration of m and n ppm,
   then is

$$E = X + Y - \frac{X \cdot Y}{100} .$$

If the actual insecticidal kill rate is greater than that calculated, the kill rate of the combination is superadditive, i.e. there is a synergistic effect. In this case, the actually observed kill rate must be greater than the value calculated from the above formula for the expected kill rate (E).

### EXAMPLE A

### Aphis gossypii Test

Solvent: 7 parts by weight of dimethylformamide
Emulsifier: 2 parts by weight of alkylaryl polyglycol ether

To produce an appropriate active ingredient formulation, 1 part by weight of active ingredient is mixed with the stated amounts of solvent and emulsifier, and the concentrate is diluted with emulsifier-containing water to the desired concentration.

Cotton plants (Gossypium hirsutum) severely infested by the cotton aphid (Aphis gossypii) are treated by spraying with the active ingredient formulation in the desired concentration.

After the desired time, the kill rate in % is determined 100% means that all of the aphids have been killed; 0% means that none of the aphids have been killed. The kill rates determined are entered into Colby's formula.

In this test, for example, the following active ingredient combination according to the present application shows a synergistically enhanced efficacy compared to the active ingredients applied individually:

TABLE A
Aphis gossypii test

| | Concentration | Kill rate in % | |
|---|---|---|---|
| Active ingredient | in ppm | after 6 days | |
| transfluthrin | 0.16 | 0 | |
| thiacloprid | 0.8 | 25 | |
| transfluthrin + Thiacloprid (1:5) | 0.16 + 0.8 | found* | calc.** |
| inventive | | 60 | 25 |

*found = effect found
**calc. = effect calculated by Colby's formula

### EXAMPLE B

### Myzus persicae Test

Solvent: 7 parts by weight of dimethylformamide
Emulsifier: 2 parts by weight of alkylaryl polyglycol ether

To produce an appropriate active ingredient formulation, 1 part by weight of active ingredient is mixed with the stated amounts of solvent and emulsifier, and the concentrate is diluted with emulsifier-containing water to the desired concentration.

Cabbage leaves (Brassica oleracea) severely infested by the green peach aphid (Myzus persicae) are treated by spraying with the active ingredient formulation in the desired concentration.

After the desired time, the kill rate in % is determined 100% means that all of the aphids have been killed; 0% means that none of the aphids have been killed. The kill rates determined are entered into Colby's formula.

In this test, for example, the following active ingredient combination according to the present application shows a synergistically enhanced efficacy compared to the active ingredients applied individually:

TABLE B
Myzus persicae test

| | Concentration | Kill rate in % | |
|---|---|---|---|
| Active ingredient | in ppm | after 1^{d} | |
| transfluthrin | 0.16 | 0 | |
| thiacloprid | 0.8 | 25 | |
| transfluthrin + thiacloprid (1:5) | 0.16 + 0.8 | found* | calc.** |
| inventive | | 40 | 25 |
| | Concentration | Kill rate in % | |
| Active ingredient | in ppm | after 6 days | |
| transfluthrin | 0.8 | 0 | |
| acetamiprid | 0.8 | 0 | |
| transfluthrin + Acetamiprid (1:1) | 0.8 + 0.8 | found* | calc.** |
| inventive | | 20 | 0 |

*found = effect found
**calc. = effect calculated by Colby's formula

### EXAMPLE C

### Phaedon cochleariae Larvae Test

Solvent: 7 parts by weight of dimethylformamide
Emulsifier: 2 parts by weight of alkyl aryl polyglycol ether

To produce an appropriate active ingredient formulation, 1 part by weight of active ingredient is mixed with the stated amounts of solvent and emulsifier, and the concentrate is diluted with emulsifier-containing water to the desired concentration.

Cabbage leaves (Brassica oleracea) are treated by spraying with the active ingredient formulation of the desired concentration and populated with larvae of the mustard beetle (Phaedon cochleariae) while the leaves are still moist.

After the desired time, the kill rate in % is determined 100% means that all beetle larvae have been killed; 0% means that none of the beetle larvae have been killed. The kill rates determined are entered into Colby's formula.

In this test, for example, the following active ingredient combinations according to the present application show a synergistically enhanced efficacy compared to the active ingredients applied individually:

TABLE C
Phaedon cochleariae larvae test

| | Concentration | Kill rate in % | |
|---|---|---|---|
| Active ingredient | in ppm | after 6 days | |
| transfluthrin | 4 | 0 | |
| acetamiprid | 4 | 0 | |
| thiacloprid | 4 | 0 | |
| transfluthrin + Acetamiprid (1:1) | 4 + 4 | found* | calc.** |
| inventive | | 40 | 0 |
| transfluthrin + Thiacloprid (1:1) | 4 + 4 | found* | calc.** |
| inventive | | 45 | 0 |

*found = effect found
**calc. = effect calculated by Colby's formula

1. Active ingredient combination comprising transfluthrin of the formula (I) 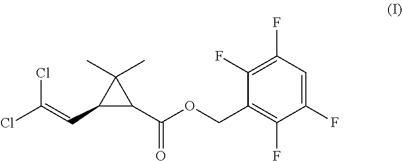
and a chloronicotinyl insecticide selected from thiacloprid of the formula (II) 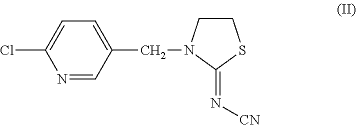
or acetampiperid of the formula (III)

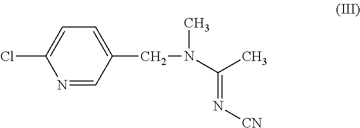

2. Active ingredient combination according to claim 1, wherein the chloronicotinyl insecticide is thiacloprid.

3. Active ingredient combinations according to claim 1, wherein the chloronicotinyl insecticide is acetamiprid.

4. Active ingredient combinations according to any of claims 1 to 3, which additionally comprise at least one active ingredient with insecticidal, acaricidal, nematicidal, antimicrobial or fungicidal activity.

5. Active ingredient combinations according to any of claims 1 to 4, which additionally comprise at least one biologically active component.

6. Composition comprising an active ingredient combination according to any of claims 1 to 5 and further auxiliaries, solvents, carriers, surfactants or extenders.

7. Granules comprising an active ingredient combination according to any of claims 1 to

8. Use of active ingredient combinations according to any of claims 1 to 5 for control of animal pests.

9. Use of active ingredient combinations according to any of claims 1 to 5 for treatment of seed.

10. Use of active ingredient combinations according to any of claims 1 to 5 for treatment of transgenic plants.

11. Use of active ingredient combinations according to any of claims 1 to 5 for treatment of seed of transgenic plants.

12. Seed which has been treated with an active ingredient combination according to any of claims 1 to 5 or the composition according to claim 6 and comprises an effective amount of the active ingredient combinations according to any of claims 1 to 5.

13. Method for controlling animal pests, characterized in that active ingredient combinations according to any of claims 1 to 5 are applied to the animal pests and/or their habitat and/or seed.

14. Method for producing insecticidal or nematicidal or acaricidal compositions, characterized in that active ingredient combinations according to any of claims 1 to 5 are mixed with extenders and/or surfactants.
